(19) United States
(12) Patent Application Publication
(10) Pub. No.: US 2007/0005324 A1
(43) Pub. Date: Jan. 4, 2007

(54) Method and apparatus for simulating circuits using s-parameters

(76) Inventors: Jian Gong, Vancouver, WA (US); Changhong Dai, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/174,071

(22) Filed: Jun. 30, 2005

(51) Int. Cl. G06F 17/50

(52) U.S. Cl. 703/14

(57) ABSTRACT

An arrangement is provided for using s-parameters to obtain characteristics of a device under test (“DUT”) between a number of selected observation locations. The DUT may be represented by a network of models such as lumped device models and transmission line models. S-parameters between the selected nodes may be measured based on the DUT representation at a plurality of frequency points. The measured s-parameters may be converted into their precision space (“p-space”) representations, which may then be submitted to a simulator to obtain the DUT characteristics at the selected observation nodes.

### BACKGROUND

1. Field

This disclosure relates generally to design, analysis, and/or simulation of a circuit or a network and, more specifically, to circuit/network simulation using scattering parameters (s-parameters).

2. Description

Traditionally, passive circuits are analyzed and simulated as networks of linear lumped devices. For example, a circuit may be modeled using only resistors or combinations of resistors, capacitors, and inductors. One advantage of such lumped network models is that they are simple and relatively easy to simulate. For a complex circuit, however, such a lumped device approach may result in a network model too complex for a simulator. When this situation occurs, the circuit may have to be first partitioned into smaller sub-circuits and each sub-circuit is then individually simulated. The simulation results from individual sub-circuits are finally patched together. Although the patched-together result may provide some characteristics of the original complex circuit, the coupling effects among different sub-circuits will have to be approximated or entirely ignored. Thus, it may be difficult to obtain accurate overall characteristics of a complex circuit using lumped network approaches. Additionally, although lumped network models may work well at lower frequencies, they may not fully capture the physical phenomena of a target circuit at higher frequencies. This is partly because coupling effects between components in the target circuit can become more significant at high frequencies than at low frequencies.

To better capture the characteristics of certain circuits/networks (e.g., bus structures or power grids) at high frequencies, transmission line models are often used to represent the circuit/network. Using this model, voltage, current, and power are naturally in the form of traveling waves along transmission lines, which in turn are represented in terms of resistance (R), capacitance (C), inductance (L), and admittance (G) networks. Although transmission line based models may be more accurate for modeling certain networks at high frequencies than the lumped device models, they do not work well for a network involving true three dimensional effects. For a large network, partitioning the network can be difficult using this model; thus, the capacity limit can be quickly reached in a practical application.

### BRIEF DESCRIPTION OF THE DRAWINGS

The features and advantages of the disclosed subject matter will become apparent from the following detailed description of the present disclosure in which:

FIG. 1 shows an example for simulating a device under test (“DUT”) using lumped device models or transmission line models, by partitioning the DUT geometrically;

FIGS. 2A-2C illustrate a two-port network and its s-parameter and y-parameter representations;

FIG. 3 shows an example for obtaining characteristics of a large-scale network by measuring the selected observation points of interest to construct a DUT 300 using s-parameter based simulation approach;

FIG. 4 illustrates a mapping between a two-dimensional (2D) s-parameter matrix to a one-dimensional (1D) precision space (p-space);

FIG. 5 illustrates one example mapping from 2D s-parameters to a 1D p-space;

FIG. 6 illustrates example partitioning of a 2D s-parameter matrix when mapping 2D s-parameters to a 1D p-space;

FIG. 7 shows one example system 700 that performs circuit simulations between selected observation nodes in a DUT using p-space representations of s-parameters; and

FIG. 8 illustrates a flowchart of one example process 800 for simulating a DUT between selected observation nodes in the DUT using p-space representations of s-parameters.

### DETAILED DESCRIPTION

An S-parameter based model is known to be capable of characterizing the high-frequency behavior of passive circuits. Once measured at any designated network terminals or pins of interest, the s-parameter model can be used to represent the network incorporating the coupling effects without approximations. Therefore, a complex circuit may not need to be partitioned geometrically. It is this unparalleled advantage that has motivated a number of explorations using s-parameters for network modeling in the literature in past years. However, when a circuit size increases, a large number of ports are needed at different frequencies to obtain a complete representation of the system characteristics. Consequently, a large amount of computing resources (e.g., memory, disk storage, and CPU time) must be consumed to characterize a complex circuit. These requirements for computing resources make the analysis/simulation of a large and complex circuit system using an s-parameter based approach impractical or even impossible in practice. Additionally, measuring s-parameters for a large circuit/network (e.g., on-chip bus structure and power grid in a microprocessor) is a big challenge for the state-of-the-art measuring devices, which can only measure s-parameters between a very limited number of ports (e.g., 2, 4 and 8). Thus, software-based measurement of s-parameters may still be needed in many cases, especially for the large circuit/network.

According to an embodiment of techniques disclosed in the present application, a device under test (“DUT”) such as the on-chip bus structure and power grid may be first represented using a lumped device based network, a transmission line based network, or other network models. Second, the observation nodes of interest may then be selected in the network representing the DUT. Third, s-parameters between the selected observation nodes may be measured through software-based frequency domain analysis, whose linear characteristics makes it orders of magnitude more efficient than its transient counterpart. Finally, the original large network will be replaced with the measured s-parameters of the DUT corresponding to the observation nodes of interest to be submitted to a generic circuit simulator (e.g., a SPICE simulator) for time-domain analysis.

Additionally, according to an embodiment of techniques disclosed in the present application, a precision space (“p-space”) concept may be used to address the aforementioned challenges associated with s-parameter models. The p-space is a one-dimensional (1 D) space that is mapped onto a continuous domain between [Min, Max], where Min and Max are the minimum and maximum values of s-parameters to be represented. The p-space may be divided into multiple slots and the number of slots is governed by the s-parameter permissible precision. As a result, 2D s-parameters may be mapped onto a 1D p-space efficiently. Furthermore, in many practical applications, a random yet common pattern may be embedded within the s-parameter data with respect to the port (observation node) indexing. Such a common pattern may be exploited to realize the efficient pattern partitioning through the space projection process and achieve the desirable reduction in data storage. This significant reduction of storage space for s-parameters in turn reduces the requirement of other computing resources (e.g., CPU speed, memory, etc.) and hence makes it feasible for a typical analyzer/simulator to analyze/simulate a complex circuit/network using s-parameters.

Reference in the specification to “one embodiment” or “an embodiment” of the disclosed subject matter means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

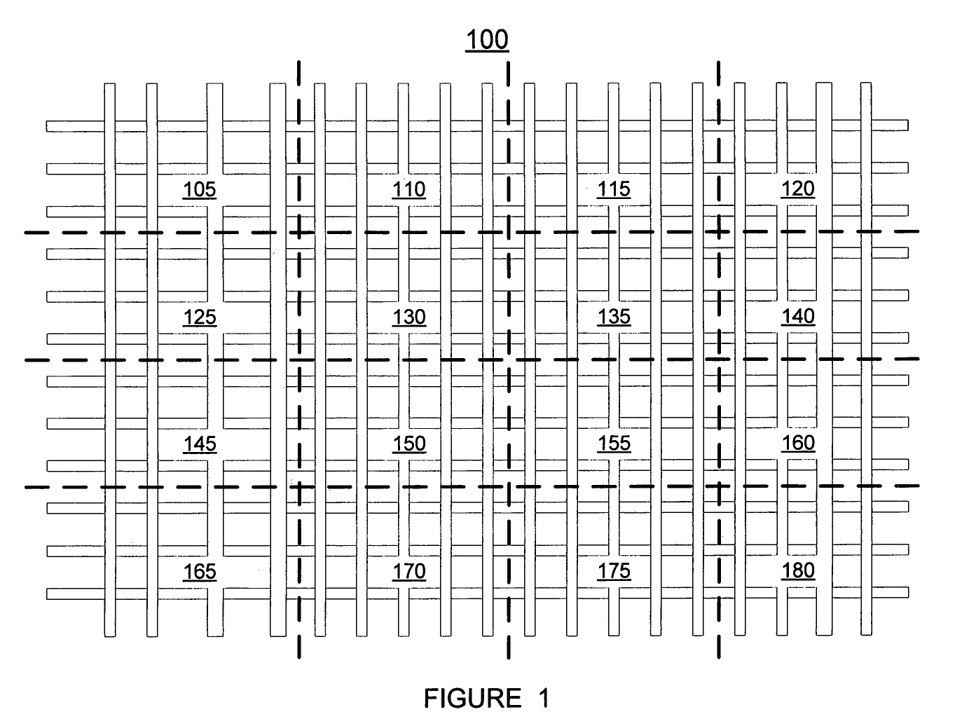

FIG. 1 shows an example for simulating a device under test (“DUT”) 100 using lumped device models or transmission line models, by partitioning the DUT geometrically. DUT 100 may be an on-chip bus structure or a power grid in an integrated circuit (e.g., a microprocessor), or any other type of circuits/networks. Typically, the DUT is three dimensional (“3D”) because it may have multi-layered conductors of various orientations. If a lumped model network or a transmission line network is used for actual transient analysis together with non-linear devices, any state-of-the-art simulator may not have enough capacity to simulate such a large-scale system. Thus, the DUT may have to be partitioned geometrically into smaller sub-circuits such as sub-circuits 105-180 shown in FIG. 1 where each sub-circuit is individually simulated. To obtain the interactions of one sub-circuit with all the others, results from individually simulated sub-circuits need to be patched together somehow. As a result, the coupling effects among different sub-circuits will have to be approximated or entirely ignored. Additionally, for a 3D circuit/network, geometrically partitioning it appropriately to minimize the possible errors introduced in the partitioning process itself may be a challenge, if not at all impossible.

An s-parameter based simulation approach may address the challenging issue encountered by the lumped device approach or the transmission line network approach for simulating a large circuit/network. Once measured at any designated network terminals or pins of interest, the s-parameter model, thus measured, can be used to represent the network incorporating the entire coupling effects without approximations. Therefore, a complex circuit may not need to be partitioned geometrically.

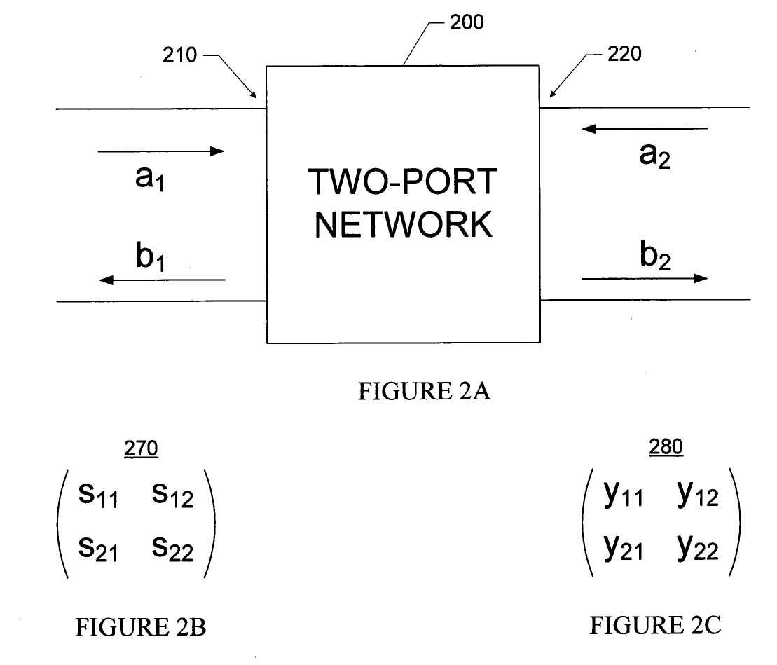

FIG. 2A illustrates a simple two-port network 200 and how s-parameters are defined. The network 200, which has two ports 210 and 220, is connected at its ports to external transmission lines. At each port, there are traveling waves at two directions: incident waves, a₁ (at port 210) and a₂ (at port 220) (applied to network 200) and reflection waves, b₁ (at port 210) and b₂ (at port 220) (reflected from network 200). If the input impedance of the network at port 210 equals the characteristic impedance of the transmission line, Z₀, any wave traveling from the source toward network 200 will not be reflected back, i.e., there will be no reflection wave b₁ (b₁=0). Similarly, if the impedance of a source for a₂ equals the characteristic impedance of the transmission line, Z₀, there will be no wave reflected away from network 200 (b₂=0). S-parameters are a set of parameters describing the scattering and reflection of these traveling waves. S-parameters are typically used to characterize high frequency networks, where simple models valid at lower frequencies may not be applicable. S-parameters are normally measured as a function of frequency. Thus, when looking at the formulae for S-parameters it is necessary to note that frequency is implied, and that the complex value (i.e., magnitude and phase) is also assumed.

Network 200 in FIG. 2A may be characterized by an s-parameter matrix 270 as shown in FIG. 2B, where

$$\begin{matrix}{s}_{11} = \frac{{b}_{1}}{{a}_{1}} {\vert}_{{a}_{2} = 0} , & ( 1 ) \\ {s}_{21} = \frac{{b}_{2}}{{a}_{1}} {\vert}_{{a}_{2} = 0} , & ( 2 ) \\ {s}_{22} = \frac{{b}_{2}}{{a}_{2}} {\vert}_{{a}_{1} = 0} , & ( 3 ) \\ {s}_{12} = \frac{{b}_{1}}{{a}_{2}} {\vert}_{{a}_{1} = 0} , & ( 4 )\end{matrix}$$

S₁₁ and S₂₁ are measured by terminating the output port (220) of network 200. S₁₁ is the input reflection coefficient of network 200, and S₂₁ is the forward transmission coefficient through the network. S₂₂ and S₁₂ are measured by terminating the input port (210) of network 200. S₂₂ is the output port reflection coefficient of network 200, and S₂₁ is the coefficient of the reverse transmission (from output to input).

Some circuit simulators cannot directly import s-parameters, but they may be able to directly accept other types of parameters such as y-parameters (admittance parameters). FIG. 2C shows a y-parameter matrix for network 200 as shown in FIG. 2A. S-parameters can be readily converted into y-parameters through matrix transformation. In case of a two-port network, the conversion is shown below:
D=((1+s₁₁)×(1+s₂₂)−s₁₂×s₂₁), (5)
y₁₁=((1−s₁₁)×(1+s₂₂)+s₁₂×s₂₁)/D, (6)
y₂₁=−2×s₂₁/D, (7)
y₂₂=((1+s₁₁)×(1−s₂₂)+s₁₂×s₂₁)/D, (8)
y₁₂=−2×s₁₂/D. (9)

The concepts of defining s-parameters for a two-port network can be expanded to multiple-port networks. For example, if there are N ports in a target network, an s-parameter matrix will contain N×N entries. Each element in the matrix may be measured in a way similar to that used to measure elements in matrix 270 as shown in FIG. 2B. For example, S₂₁ may be measured by terminating all ports other than port one, i.e.

$${s}_{21} = \frac{{b}_{2}}{{a}_{1}} {\vert}_{{a}_{2} = {a}_{3} = ⋯ = {a}_{N} = 0.} \qquad ( 10 )$$

Similarly, y-parameters of the same N-port network may be obtained by converting from corresponding s-parameters.

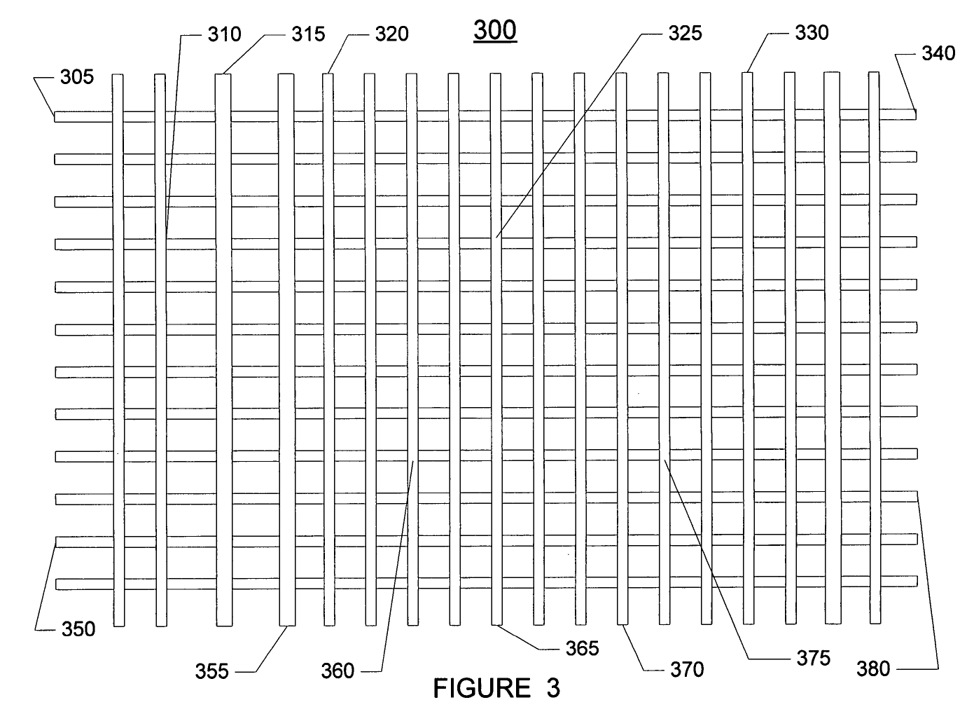

FIG. 3 shows an example of obtaining characteristics of a large-scale network by measuring the selected observation points of interest to construct a DUT 300 using the s-parameter based simulation approach, according to an embodiment of the disclosed subject matter. A number of observation nodes of interest such as nodes 305-380 may be selected in the DUT. S-parameters among the selected observation nodes may be directly measured using a measuring device. In practice, even a state-of-the-art s-parameter measuring device can only measure s-parameters for a very limited number of nodes (e.g., 2, 4 or 8). However, for a large circuit/network, observation nodes may need to be several hundreds (e.g., 500) or even several thousands (e.g. 2000) to obtain a relatively complete picture of the system behavior. Thus, a software-based approach may need to be used to measure s-parameters among the selected observation points.

To use a software-based measuring tool, DUT 300 needs to be first represented in terms of some types of models. Typically, lumped device models (e.g., resistor only models or models based on a combination of resistors, capacitors, and inductors) or transmission line models may be used. To represent the original DUT as accurately as possible, there may need to be a large number of such linear device models, each model representing only a very small portion of the DUT. A resulting representation of the DUT may be a large-scale network of such models. A software-based s-parameter measuring tool uses this resulting representation of the DUT as an input parameter and measures s-parameters among the selected observation nodes.

The measured s-parameters between the selected observation nodes may then be submitted to a generic circuit simulator such as a SPICE for complicated transient analysis. The simulator may be able to accept s-parameters directly. The simulator may only be able to accept other types of network parameters (e.g., y-parameters). In that case, the measured s-parameters may be converted into the type of parameters acceptable to the simulator.

To obtain enough s-parameter samples that reflect circuit characteristics in the entire frequency domain, s-parameters at different frequency points need to be measured. When s-parameters measured from different frequencies are put together, the amount of data can increase rapidly even with a modest number of observation nodes. For example, 500 or more observation nodes (ports) may be needed to analyze an on-chip bus structure or a power grid in modern microprocessor technology. At each measuring frequency, there would be 500×500 entries in an s-parameter matrix. Assuming that 1,000 frequency points are measured and each s-parameter value requires 8-bytes storage, the total amount of storage needed for all the s-parameters would be 2 Gigabytes (GB). It is possible for a state-of-the-art simulator to process such an amount of data, but it requires a lot of computational resources (e.g., memory and processor speed). A careful analysis of these s-parameters can reveal that it is not always necessary to store such an amount of data. To improve the speed and efficiency of a simulator, it is desirable to use the minimal information for a large amount of s-parameters so that the requirement for a large storage space and computing power can be avoided.

According to one embodiment of techniques disclosed in the present application, a 1D p-space may be used to represent s-parameters in 2D s-parameter matrices. Values of s-parameters typically fall within a certain range. For a passive circuit, for example, this range is between −1 and 1. The magnitudes of s-parameters are normally measured in decibel (dB), which is 20×log (magnitude). In practice, there is permissible precision associated with s-parameters, especially when s-parameters are measured by a physical device. For example, the precision in a range from 40 dB (10⁻²) to −60 dB (10⁻³) may require careful calibrations during measurement; the precision between −60 dB (10⁻³) and −80 dB (10⁻⁴) may fall in the uncertainty of a typical s-parameter measurement instrument setup; and the precision below −80 dB (10⁻⁴) or −100 dB (10⁻⁵) may be beyond the practical measuring techniques. In other words, all of the s-parameter magnitudes of a circuit/network should fall within a certain value range with a given permissible precision. The concept of a p-space, P{M}, as disclosed herein, takes advantage of this characteristic of s-parameters. It uses a 1D space whose value range corresponds to the magnitude value range of s-parameters (assuming the p-space range is from Min to Max). The space is equally divided into M slots, where M is determined as follows,

$$\begin{matrix}M = ( Max - Min ) \times PScale , & ( 11 ) \\ PScale = \frac{1}{SPrecision} . & ( 12 )\end{matrix}$$

where SPrecision represents the permissible precision of s-parameter magnitudes, and PScale is the scale of the p-space. For example, if the magnitude value range of s-parameters is from −1 to 1 and the permissible precision is 10⁻⁴, a corresponding p-space will also have a value range from −1 to 1 that is equally divided into 2×10⁴ slots. Using the p-space so designed, the magnitude of any s-parameter can be represented by a unique slot in the p-space. Note that in some embodiments, a p-space may be divided into a number of slots, which are not necessarily uniform over the range.

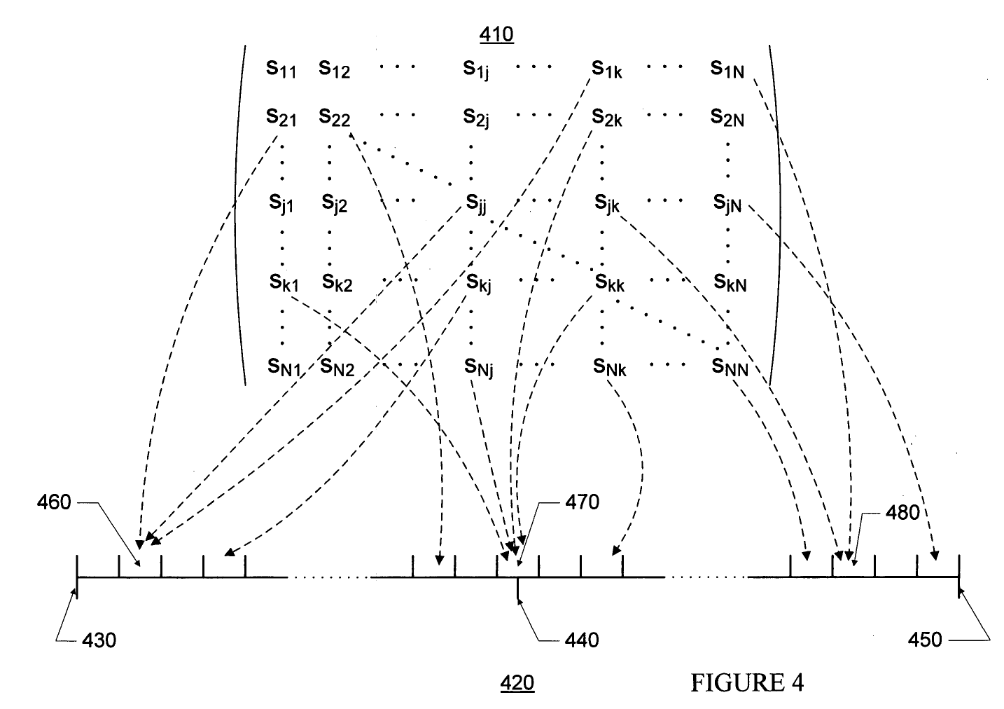

FIG. 4 illustrates how a 2D s-parameter matrix 410 may be mapped to a 1D p-space 420. P-space 420 has a minimum value 430 and a maximum value 450. The value of the middle point 440 of the p-space depends on the minimum value and the maximum value. For example, if the minimum value is −1 and the maximum value is 1, the value of the middle point is 0. The space is divided into a number of slots (e.g., slot 460, 470, and 480), where the number of slots depends on the scale of the p-space, the minimum value, and the maximum value of the p-space. The scale of p-space 420 may in turn be determined by the permissible precision of s-parameters in matrix 410. Each s-parameter in matrix 410 can be represented by a unique slot in p-space 420. For example, S₂₁, Sⱼⱼ, and S₁ₖ may be represented by slot 460; Sₖ₁, S_{Nj}, S₂ₖ, and Sₖₖ may be represented by slot 470; and S_{1N} and Sⱼₖ may be represented by slot 480.

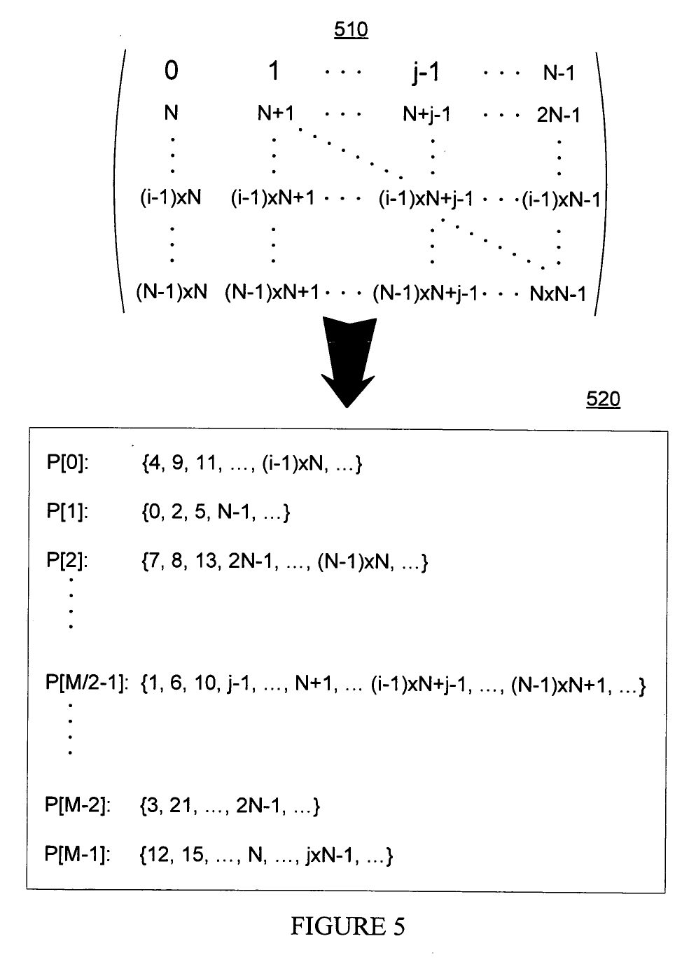

FIG. 5 illustrates one example mapping from s-parameters in a 2D matrix 510 to a 1D p-space. Each s-parameter in a matrix may be represented by a two-integer index. For example, S₁₁ may be represented by (1,1); and Sᵢⱼ may be represented by (i,j). Such representation requires two integers to represent one s-parameter in the matrix. To reduce storage space, each s-parameter in the matrix may be represented by a single-integer index. For example, as shown in matrix 510, Sᵢⱼ may be represented by (i−1)×N+j−1, where N is the total port number in a circuit/network to be analyzed. In one embodiment, slots in a p-space may be represented by an array of pointers, P[0], P[1], . . . , P[M−1] as shown in box 520. Each pointer in the array may point to indices of s-parameters which are represented by the corresponding slot. For example, P[0] may point to 4, 9, 11, . . . , (i−1)×N, . . . ; and P[M−2] may point to 3, 21, . . . , 2N−1, . . . . In another embodiment, slots in a p-space may be represented by a link table or other data structures. For some large networks/circuits, many entries in s-parameter matrices may be zeros, exhibiting a certain sparse feature. For those zero s-parameters, it may not be necessary to store their indices when mapping s-parameters in matrices to the p-space so that the storage requirement can be reduced.

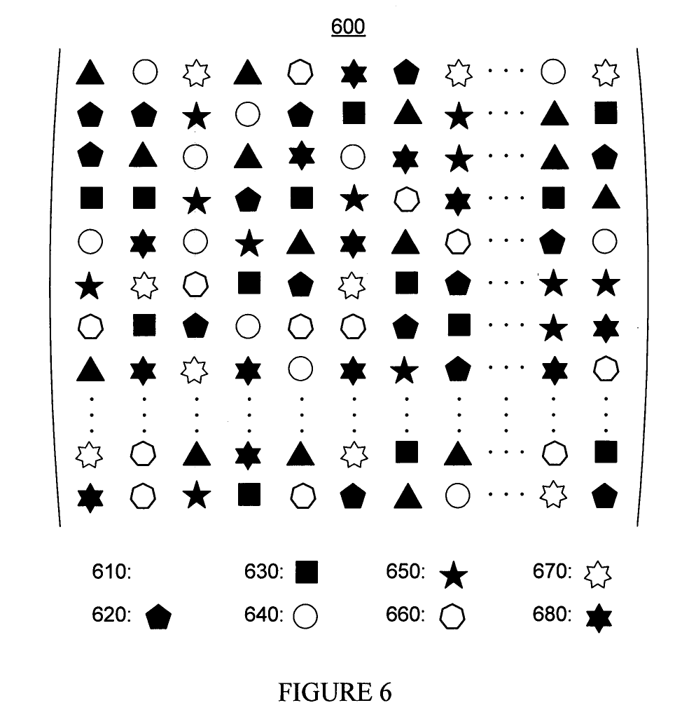

The process of mapping a 2D s-parameter matrix to a 1D p-space is equivalent to partitioning the 2D s-parameter matrix into M patterns with each pattern projecting into one slot in the p-space; where M is the total number of slots in the p-space. FIG. 6 illustrates example partitioning of a 2D s-parameter matrix when mapping 2D s-parameters to a 1D p-space. S-parameter matrix 600 is partitioned into multiple patterns (e.g., 610, 620, 630, 640, 650, 660, 670, and 680). Each pattern may contain one or more s-parameters, which is/are projected to a single p-space slot.

S-parameters that fall into the same p-space slot typically have the same or similar physical characteristics. For example, they may represent a coupling relationship between two ports of geometrically similar networks. Thus, the partitioning process helps identify those s-parameters that have the same or similar coupling effects. Since the relative relationships in terms of certain geometrical characteristics typically do not change from one frequency to another, it may not be necessary to partition every s-parameter matrix at every measuring frequency. Normally, only the s-parameter matrix at a critical frequency point (e.g., frequency=0 Hz) or a combination of the representative samples is partitioned. The resulting partitioning patterns may apply to s-parameter matrices at other measuring frequency points. Therefore, the p-space helps obtain the common partitioning patterns for s-parameter matrices at different measuring frequency points. However, the same partitioning patterns across different frequencies do not imply that s-parameters in each pattern always have the same single value at different frequencies. In other words, partitioning patterns may remain the same for different frequencies, and s-parameters in a particular pattern may have sufficiently the same value at a measuring frequency point, but the s-parameter value corresponding to this particular pattern may change from one frequency to another.

The common partitioning patterns across different measuring frequency points may be stored in a table or other types of data structure such as the one shown in box 520 of FIG. 5. Box 520 shows a mapping relationship between entries in an s-parameter matrix and the p-space slots. This mapping relationship is used to convert original s-parameters into their p-space representations to save storage space and later to project p-space representations of s-parameters back to entries in original s-parameter matrices during the simulation process.

One function of the mapping relationship between one s-parameter matrix at a particular frequency and the p-space is to reduce the storage space required for original s-parameters. Since all the s-parameters in a partitioning pattern that map to the same p-space slot have substantially the same value (there may be some minor variations from one s-parameter to another partly due to permissible measuring errors), it is necessary to store only one value for all the s-parameters in this partitioning pattern. Thus, instead of storing N×N s-parameters, only M values of s-parameters may need to be stored, where N is the number of ports of the target circuit and M is the number of slots in the p-space. For an s-parameter matrix at a measuring frequency point other than the particular frequency used to obtain the mapping relationship, the same mapping relationship applies and only M values of s-parameter, rather than N×N s-parameters, need to be stored. As a result, a total number of N×N×K s-parameters are converted into a total number of M×K p-space representations of s-parameters, where K is the number of measuring frequency points.

The M×K p-space representations of s-parameters may be stored in a pointer array or any other data structure. If a pointer array is used, a pointer in the array may represent a p-space slot and the data pointed to by the pointer includes s-parameter representations of all the s-parameters in a partitioning pattern corresponding to the p-space slot at different measuring frequencies. An s-parameter representation is the common value of all the s-parameters in a partitioning pattern at a measuring frequency point. One advantage of p-space representations of s-parameters is that there is little approximation for original s-parameters. The basic idea of p-space representations is to identify those s-parameters that have substantially the same value and to store only this common value for them.

The p-space representations can significantly reduce the storage space required for original s-parameters. For example, for a passive circuit/network with 500 observation nodes (ports) and 1,000 measuring frequency points, it may require 2 GB storage space for s-parameters (assuming 8 bytes for each s-parameter). In contrast, using a p-space with a scale of 10⁴ (i.e., the permissible precision of s-parameter is 10⁻⁴), the total space required to store p-space representations of original s-parameters is 160M bytes (2×10⁴×1,000×8 bytes, assuming the value range of the p-space is from −1 to 1). The ratio of the total storage using p-space representation over that using the conventional storage is about 1:12.5 in this case. Note that the more observation nodes are selected, the larger storage saving ratio can be attained using a p-space technique.

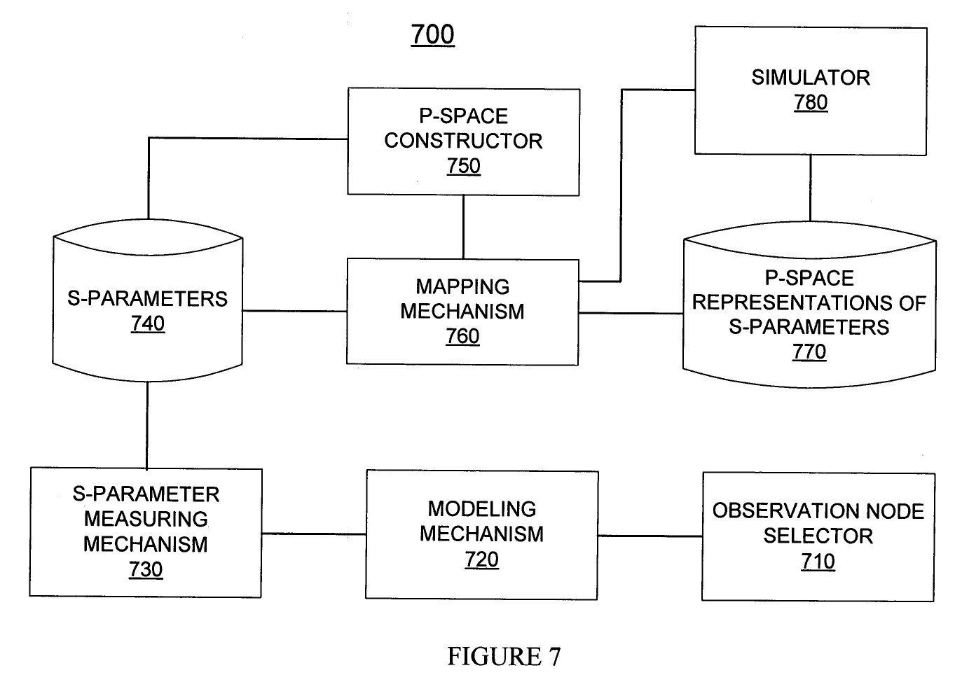

FIG. 7 shows one example system 700 that performs circuit simulations between selected observation nodes in a DUT using p-space representations of s-parameters. System 700 comprises an observation node selector 710, a modeling mechanism 720, an s-parameter measuring mechanism 730, a p-space constructor 750, a mapping mechanism 760 and a simulator 780. Observation node selector 710 may select a number of observation nodes of interest. The observation node selector may be simply a person or a mechanism guided by a person. The observation node selector may also be a software or hardware module that selects nodes of interest according to a set of given rules.

Modeling mechanism 720 may use a network of selected models (e.g., lumped device models or transmission line models) to represent the DUT. To represent the DUT as accurately as possible, the DUT may be divided into a large number of small sections with each section being represented by a model. The modeling mechanism may use some automatic tools to perform the modeling process. For example, the DUT may be described using one high level hardware description language and a modeling tool may produce a representation of the DUT using the selected models based on the description. Other methods may also be used to produce a representation of the DUT. The modeling mechanism may also need to coordinate with the observation node selector to identify nodes corresponding to the selected observation nodes in the DUT representation.

S-parameter measuring mechanism 730 may measure s-parameters among the observation nodes selected by observation node selector 710. In one embodiment, s-parameters may be measured directly from the DUT. In such a case, it might not be necessary to use a network of models to represent the DUT. In another embodiment, a software-based measuring tool may be used to measure s-parameters on the selected nodes according to s-parameter definition as shown in Equations (1)-(4) and (10). When a software-based measuring tool is used, the resulting s-parameters may have a higher precision than those measured by a physical device. The s-parameter measuring mechanism may measure the s-parameters at different measuring frequency points. At each measuring frequency point, the s-parameters obtained may fill an N×N matrix, where N is the number of selected observation nodes. All the s-parameters obtained by the s-parameter measuring mechanism may be stored in storage 740.

P-space constructor 750 may construct a 1D p-space based on s-parameters stored in 740. A critical s-parameter matrix (e.g., the one at DC frequency) or a combination of the representative s-parameter matrices may be selected to obtain the mapping relationship from s-parameter matrices to the p-space. The value range of the p-space reflects the value range of s-parameters in the selected s-parameter matrix. The scale of the p-space is determined based at least in part on the permissible precision of s-parameters in the selected s-parameter matrix. In one embodiment, the p-space may be divided equally into multiple slots, where the number of slots may be determined according to Equation (11). In another embodiment, slots might not be linearly uniform. For example, a certain sub-range of values in the p-space may be more finely divided than others if this sub-range corresponds to many more s-parameters than others. Additionally, a p-space may be divided logarithmically equally into multiple slots. An array of pointers may be used to represent multiple slots in the p-space.

Mapping mechanism 760 may generate a mapping relationship between the selected s-parameter matrix and the p-space constructed by p-space constructor 750. The mapping relationship may be obtained by a partitioning component (not shown in FIG. 7) in the mapping mechanism. The partitioning component partitions the selected s-parameter matrix into one or more patterns. For a passive circuit/network where the value range of s-parameters is between −1 and 1, the partitioning process is sort free because each s-parameter can be directly mapped to a slot of the p-space without a further sorting process. All of the s-parameters that map to the same p-space slot belong to one pattern and have the same or similar characteristics. All of the s-parameters in each pattern have substantially the same value and hence only one value needs to be stored for them. The partitioning patterns for the selected s-parameter matrix typically apply to s-parameter matrices at other measuring frequency points. The resulting mapping relationship may be stored in a pointer array or other types of data structures such as the box 520 shown in FIG. 5, where each pointer representing a p-space slot points to indices of s-parameters in the corresponding partitioning pattern.

The mapping mechanism may also comprise a projection component (not shown in FIG. 7), which may provide forward (from original s-parameters to p-space) and backward (from p-space back to original s-parameters) projections between original s-parameters and their p-space representations, based on the mapping relationship obtained above. The projection component projects forward s-parameters in each partitioning pattern from an s-parameter matrix to its corresponding p-space slot according to the mapping relationship so that all the s-parameters in the pattern may be represented by their common value. Through the forward projection, original s-parameter matrices are converted into p-space representations, resulting in significant reduction in storage space. During the actual analysis/simulation process, the projection component also functions to project a p-space representation back to an original s-parameter matrix to let simulator 780 know which s-parameters the representation represents, based on the stored mapping relationship. The resulting p-space representations of s-parameters stored in 740 may be stored in storage 770.

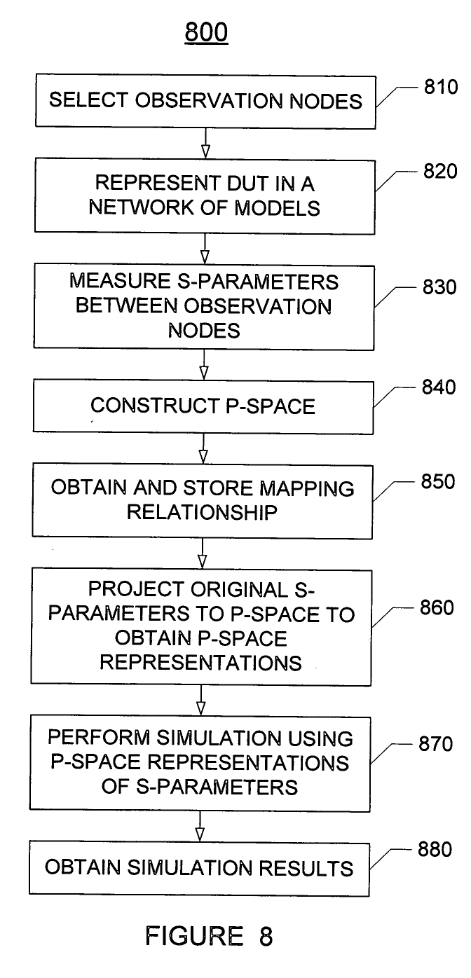

FIG. 8 illustrates a flowchart of one example process 800 for simulating a DUT between selected observation nodes in the DUT using p-space representations of s-parameters. Process 800 starts with a DUT. At block 810, a number of observation nodes in the DUT may be selected. The observation nodes may be selected according to a set of given rules. At block 820, the DUT may be represented using a network of selected models (e.g., lumped device models). This may be performed automatically by a tool which is provided with a description of the DUT using a hardware description language. Once the DUT is represented by a network of models, the observation nodes selected at block 810 may be identified in the DUT representation. At block 830, s-parameters between the selected observation nodes may be measured by conducting frequency domain analysis of the DUT. S-parameters may be measured at different frequencies according to s-parameter definitions as shown in Equation (1)-(4) and (10). The s-parameters obtained at block 830 may include a 2D matrix of s-parameters for each measuring frequency point. These s-parameters may be stored in a storage device for further processing.

At block 840, a p-space may be constructed based on a selected s-parameter matrix from s-parameters obtained at block 830. For example, the s-parameter matrix at frequency 0, the highest frequency, or a combination of frequency samples, may be selected. The value range of the p-space corresponds to the value range of s-parameters in the selected s-parameter matrix. The scale of the p-space may be determined by the permissible precision of s-parameters according to Equation (12). In one embodiment, a precision not so fine as the finest precision of the s-parameters may be used to determine the p-space scale if the number of s-parameters corresponding to the finest precision is small. As described along with FIG. 7, the p-space may be divided equally into a number of slots in a linear manner. The number of slots may be determined according to Equation (11). The p-space may also be divided unequally or equally in a logarithmical manner.

At block 850, the selected s-parameter matrix may be used to obtain a mapping relationship between s-parameters and the p-space. First, the selected s-parameter matrix may be partitioned into patterns by scanning each entry in the matrix, mapping the entry to a p-space slot, and pointing the p-space slot to the index of the entry. Second, the mapping relationship between a p-space slot and indices of those s-parameters in the selected matrix may be stored using a pointer array or other types of data structure such as the one shown in box 520 of FIG. 5. The resulting mapping relationship applies to s-parameter matrices at other measuring frequency points. At block 860, all the s-parameters in the matrix of choice may be projected to the p-space (i.e., forward projection) based on the mapping relationship obtained at block 850. The forward projection converts original s-parameters into their p-space representations by using only one value to represent all the s-parameters in a partitioning pattern at each measuring frequency point. The resulting p-space representations of original s-parameters may significantly reduce storage space required for original s-parameters. The p-space representations thus obtained may be stored in a storage device. Processing in blocks 810 through 860 may be performed before DUT simulation so that the computing capacity of a simulator may be efficiently used for simulation purposes.

At block 870, the DUT may be simulated using p-space representations of original s-parameters of the DUT. The simulation process involves backward projection from a p-space representation to original s-parameters in a matrix. The backward projection may be performed by looking up the mapping relationship obtained at block 850. Simulation results may be obtained at block 880. Since the storage space needed for p-space representations of s-parameters is much smaller than original s-parameters, less memory and other computing power is required for simulating the target circuit/network. Thus, a typical simulator may be well equipped for such a simulation task, and the simulation process can be completed faster with p-space representations of s-parameters than with s-parameters directly.

Although an example embodiment of the disclosed subject matter is described with reference to block and flow diagrams in FIGS. 1-8, persons of ordinary skill in the art will readily appreciate that many other methods of implementing the disclosed subject matter may alternatively be used. For example, the order of execution of the blocks in flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the scope of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A method for analyzing a device, comprising:
selecting a plurality of observation locations in said device;
measuring s-parameters among said plurality of observation locations;
generating precision space (“p-space”) representations of said s-parameters; and
simulating said device to obtain characteristics between said plurality of observation locations based at least in part on said p-space representations.

2. The method of claim 1, wherein said device comprises at least one of a circuit and a network.

3. The method of claim 1, wherein said device comprises at least one of an interconnect structure and a power grid in a processor.

4. The method of claim 1, wherein measuring s-parameters comprises:
representing said device with a network of a plurality of models; and
performing frequency domain analysis of said device to obtain interactions between said plurality of observation locations.

5. The method of claim 4, wherein said plurality of models comprises at least one of lumped device models and transmission line models.

6. The method of claim 1, wherein generating p-space representations of said s-parameters comprises constructing a p-space based at least in part on said s-parameters.

7. The method of claim 6, wherein constructing a p-space comprises determining a precision scale based at least in part on said s-parameters.

8. The method of claim 7, wherein said p-space is one dimensional (1D), and said s-parameters are stored in at least one two dimensional (2D) matrix.

9. The method of claim 8, wherein said p-space is divided into multiple slots based at least in part on said precision scale.

10. The method of claim 8, wherein generating p-space representations of said s-parameters comprises creating a mapping between said at least one 2D matrix and said 1D p-space.

11. The method of claim 10, wherein simulating said circuit comprises projecting a 1D p-space representation of s-parameters back to s-parameters in a 2D matrix based on said mapping.

12. The method of claim 10, wherein creating a mapping further comprises partitioning said at least one 2D matrix based on said p-space.

13. The method of claim 10, wherein generating p-space representations of said s-parameters comprises a forward projection from said at least one 2D matrix to said 1D p-space.

14. An apparatus for analyzing a device, comprising:
an observation location selector to select a plurality of observation locations in said device;
a measuring mechanism to measure s-parameters among said plurality of observation locations;
a mapping mechanism to map said s-parameters to a precision space (“p-space”) and to generate p-space representations of said s-parameters; and
a simulator to simulate said device to obtain characteristics between said plurality of observation locations using said p-space representations.

15. The apparatus of claim 14, wherein said device comprises at least one of a circuit and a network.

16. The apparatus of claim 14, wherein said device comprises at least one of an interconnect structure and a power grid in a processor.

17. The apparatus of claim 14, further comprising a modeling mechanism to represent said device with a network of a plurality of models.

18. The apparatus of claim 15, wherein said plurality of models comprises at least one of lumped device models and transmission line models.

19. The apparatus of claim 14, further comprising a p-space constructor to construct a precision space (p-space) based at least in part on said s-parameters.

20. The apparatus of claim 19, wherein said p-space is one dimensional (1D), and said s-parameters are stored in at least one two dimensional (2D) matrix.

21. The apparatus of claim 20, wherein said p-space constructor determines a precision scale based at least in part on said s-parameters, and said p-space is divided into multiple slots based at least in part on said precision scale.

22. The apparatus of claim 14, wherein the mapping mechanism comprises:
a partitioning component to partition said at least one 2D matrix based on said p-space; and
a projection component to create projections between said at least one 2D matrix and said 1D p-space, said projections including a forward projection from said at least one 2D matrix to said 1D p-space and a backward projection from said 1D p-space to said at least one 2D matrix.

23. The apparatus of claim 22, wherein said simulator simulates said circuit based at least in part on said backward projection.

24. An article comprising a machine-readable medium that contains instructions, which when executed by a processing platform, cause said processing platform to perform operations comprising:
selecting a plurality of observation locations in said device;
measuring s-parameters among said plurality of observation locations;
generating precision space (“p-space”) representations of said s-parameters; and
simulating said device to obtain characteristics between said plurality of observation locations based at least in part on said p-space representations.

25. The article of claim 24, wherein said device comprises at least one of a circuit and a network.

26. The article of claim 24, wherein said device comprises at least one of an interconnect structure and a power grid in a processor.

27. The article of claim 24, wherein measuring s-parameters comprises:
representing said device with a network of a plurality of models; and
performing frequency domain analysis of said device to obtain interactions between said plurality of observation locations.

28. The article of claim 27, wherein said plurality of models comprises at least one of lumped device models and transmission line models.

29. The article of claim 24, wherein generating p-space representations of said s-parameters comprises constructing a p-space based at least in part on said s-parameters.

30. The article of claim 29, wherein said p-space is one dimensional (1D), and said s-parameters are stored in at least one two dimensional (2D) matrix.

31. The article of claim 30, wherein constructing a p-space comprises determining a precision scale based at least in part on said s-parameters, said p-space is divided into multiple slots based at least in part on said precision scale.

32. The article of claim 30, wherein generating p-space representations of said s-parameters comprises creating a mapping between said at least one 2D matrix and said 1D p-space.

33. The article of claim 32, wherein simulating said circuit comprises projecting a 1D p-space representation of s-parameters back to s-parameters in a 2D matrix based on said mapping.

34. The article of claim 32, wherein creating a mapping further comprises partitioning said at least one 2D matrix based on said p-space.

35. The article of claim 32, wherein generating p-space representations of said s-parameters comprises a forward projection from said at least one 2D matrix to said 1D p-space.
